(19) United States
(12) Patent Application Publication
(10) Pub. No.: US 2017/0316089 A1
(43) Pub. Date: Nov. 2, 2017

(54) SYSTEM AND METHOD FOR CAPTURING, ARCHIVING AND CONTROLLING CONTENT IN A PERFORMANCE VENUE

(71) Applicant: MusicPlay Analytics, LLC, Cincinnati, OH (US)

(72) Inventors: Eron Bucciarelli-Tieger, Englewood, OH (US); Eric Fulkert, Fairfield, OH (US)

(21) Appl. No.: 15/584,555

(22) Filed: May 2, 2017

Related U.S. Application Data
(60) Provisional application No. 62/330,554, filed on May 2, 2016.

(51) Int. Cl. G06F 17/30; H04H 60/27; H04H 60/58; H04H 60/05; G11B 27/00; G11B 27/031

(52) U.S. Cl. CPC G06F 17/30749; H04H 60/58; H04H 60/27; G11B 2220/2516; G11B 27/031; G11B 27/002; G06F 17/30011; H04H 60/05; G11B 2220/412

(57) ABSTRACT

A system for auditing performance data in commercial venues having one or more computing devices located in venues where live or pre-recorded music is performed. The computing devices capture and store content in each venue using at least one audio input configured for professional audio performances. The computing devices store the content as a content data record with associated identifiers for date, time, and venue location. The content data records are transferred from each venue to a central server. Encryption keys encrypt the content data records from each venue to verify the authenticity of the content transmitted from the venues to the server. The server includes a processor for opening, reviewing, and separating the content data records from each venue into distinct files, each file comprising an individual work performed in the venue. The system further includes an interface for providing access to the archived content data records at the server.

### FIELD OF THE INVENTION

The present invention relates to the performance of music, video, and other media in a commercial venue and, more particularly, to systems and methods for capturing and archiving performance content from individual venues, as well as providing an interface to an archive record of performance content for attributing performance rights as well as selecting venue music and ad content.

### BACKGROUND OF THE INVENTION

Concerts and music venues are a popular form of entertainment in our culture. This is particularly true with the younger generations most sought after by advertisers. Many restaurants, bars, nightclubs, and other commercial establishments play music or other audio material for the pleasure of their patrons. The music may be obtained from a private audio source service, such as Muzak®, or may be broadcast music from the radio, a cable television channel, or even from a private collection of music. Additionally, clubs and other music venues may host live band performances by a wide variety of performers and in a wide range of music genres. The demographics and number of patrons at a particular band performance or music venue can vary greatly depending upon the popularity of the band performing or the music genre being broadcast in the venue. A commercial establishment oftentimes broadcasts a generic music list without the ability to customize the play list selections to a particular music genre, or to the demographics or preferences of the patrons who frequent the establishment.

While advertising is commonly used within a commercial establishment as an additional revenue source, this advertising may also be generic to the commercial business, and not at all related to the music being performed at a particular date and time, or to the type of crowd in attendance. Celebrity endorsements are a common form of marketing products and services, particularly when trying to target a specific demographic with marketing pitches. However, there currently is no reliable way of linking the endorser with the demographics of the audience actually receiving the product promotion, or to even verify that the endorsement was broadcast in the venue at the designated date and time. Thus, while particular subsets of the population may have a particular affinity for a performer or band, there is currently no reliable way of targeting endorsements by that band to the most receptive demographic groups. Additionally, advertisers seek information regarding the effectiveness of particular advertisements or celebrity endorsements. However, there is currently no reliable method available to accurately monitor and track crowd demographics and audience size during live concerts or music broadcasts, and to verify, through audio and/or video signals, the broadcast of an advertisement in a commercial establishment. Access to data related to crowd size, demographics, and music preferences within a commercial broadcast venue would have beneficial application in product marketing and other commercial usage. However, despite the commercial advantages, there are currently no reliable systemic platforms available for accurately collecting, cataloging, and storing data regarding crowd demographics for a particular performance or music broadcast in a commercial establishment, or for making this data available to advertisers for use in valuing and purchasing broadcast ad inventory. Additionally, there is presently no system for synchronizing user specific marketing via mobile phone applications contemporaneously with the presentation of an advertisement in a venue.

U.S. Patent Application Publication No. 2015/0213240, by the Applicant herein, entitled System and Method for Tracking Copyrighted Audio Material Broadcast in a Commercial Establishment, which is incorporated herein by reference, describes a system and method for tracking copyrighted audio material being performed or broadcast in a commercial establishment. The system and method described in the published application detects audio signals played in a commercial establishment and converts the audio signals into a data format for comparison with a database of copyrighted audio material. The identified music list is stored in a usage database and is catalogued by the specific audio material performed, the establishment in which the audio material was broadcast or performed, and the date and time of the broadcast or performance. The usage database provides the ability to generate statistics and analytics related to the frequency, music genres, and locations of music performances and broadcasts. However, the usage database described in the published application provides only a playlist, and not a full audio archive that can provide complete proof of a broadcast or performance in the case of a rights holder audit.

Accordingly, a need exists for a system and method for generating a full archive of all audio material broadcast or performed within commercial establishments. Further, it is desirable to enhance this full audio archive with a system and method of monitoring and cataloging audience demographic data for the performances or broadcasts. This archive of all content from a performance venue or establishment provides a data source for performing rights attribution, as well as marketing opportunities. In addition, it is desirable to have a system and method of customizing music broadcasts within a commercial establishment based upon multiple factors including: patron demographics; band information, including genre and top songs; and venue location, size, and type. Additionally, it is desirable to have a method for identifying music performers having particular popularity with designated demographic groups to enable advertisers to target demographic groups with product endorsements. Additionally, it is desirable to have a method of determining crowd demographics associated with a commercial establishment to enable targeted advertising to specific demographic groups at selected commercial establishments. Furthermore, it is desirable to have a system and method for altering the advertising in a commercial establishment based on the popularity of the band performing in the establishment. Still further, it is desirable to have a method for reaching out to patrons in a music venue or concert with product pushes, selective advertising, or to dynamically alter a music play list, based on captured audience data.

### SUMMARY OF THE INVENTION

In a first aspect, a system is provided for auditing performance data in commercial venues having one or more computing devices located in venues where live or pre-recorded music is performed. The computing devices capture and store content in each venue using at least one audio input configured for professional audio performances. The computing devices store the content as a content data record with associated identifiers for date, time, and venue location. The content data records are transferred from each venue to a central server. Encryption keys encrypt the content data records from each venue to verify the authenticity of the content transmitted from the venues to the server. The server includes a processor for opening, reviewing, and separating the content data records from each venue into distinct files, each file comprising an individual work performed in the venue. The system further includes an interface for providing access to the archived content data records at the server.

In a second aspect, a method is provided for auditing performance data in commercial venues. The method includes locating a computing device in one or more commercial venues where live or pre-recorded music is performed. Each computing device captures and stores live and pre-recorded performances occurring in the venue using at least one audio input configured for professional audio performances. The computing device stores the performances within the associated venue as a content data record with associated identifiers for date, time, and venue location. The content data records are encrypted to verify the authenticity of the content data, and transmitted from each venue computing device to a central server. At the server, the content data records are archived and opened reviewed and separated into distinct files, each file comprising an individual audio and/or video work performed in the venue. Using an interface associated with the server, the archived content data records are accessed for identifying individual performance works by venue for attribution of performance rights.

In a third aspect, a device for collecting audience data and providing broadcasts within a performance venue is provided comprising a light bulb, a power source for illuminating the light bulb, a wireless interface for communicating with a computing device in the venue, a microcomputer, and a packet sniffer.

In a fourth aspect, a system for capturing audience data and for broadcasting marketing content in a performance venue is provided comprising a plurality of lighting devices, each of the lighting devices including a light bulb, a power source for illuminating the light bulb, a wireless interface, a microcomputer, and a packet sniffer for intercepting and recording portable computing device identifiers of patrons entering the venue. The system also includes a computing device in the venue for communicating with the lighting devices through the wireless interface. The lighting devices capture patron data using the packet sniffers and communicate the patron data to the venue computing device.

In a fifth aspect, a method is provided for driving advertising in a performance venue, the method including the steps of detecting the entrance of a patron into a venue, adding each patron entrance to an audience count for the venue, determining demographic data for patrons using identifiers associated with patron portable computing devices carried into the venue, and correlating patron demographic data with music performances occurring within the venue to develop suggested content for the venue.

The above and other objects and advantages of the present invention shall be made apparent from the accompanying drawings and the description thereof.

### BRIEF DESCRIPTION OF THE DRAWINGS

FIG. 1 is a block diagram of the components of an exemplary venue computing device for the content capturing and control system of the present invention;

FIG. 2A is a perspective view of the back side of an exemplary venue computing device for use in the content capturing and control system, illustrating audio input/output ports for the system;

FIG. 2B is a perspective view of the front side of the exemplary computing device shown in FIG. 2A;

FIG. 3 is a block diagram of the components of an exemplary central server for the content capturing and control system of the present invention;

FIG. 4 is a block diagram of the components of an exemplary lighting device of the audio system;

FIG. 5 is a diagrammatic view of a network of lighting devices connected to a computing device in a commercial venue;

FIG. 6 is a block diagram illustrating an exemplary method of operating a venue computing device for the content capturing and control system;

FIG. 7 is a block diagram illustrating an exemplary method of operating a central server for the content capturing and control system;

FIG. 8 is a block diagram illustrating an exemplary method of operating a central server interface for the system;

FIG. 9 is a block diagram illustrating an exemplary method of operating a lighting device in accordance with the audio monitoring and control system of the present invention; and

FIG. 9A is a block diagram illustrating an exemplary method for tracking patron ingress and egress from a venue.

The accompanying drawings, which are incorporated in and constitute a part of this specification, illustrate embodiments of the invention and, together with a general description of the invention given above, and the detailed description of the embodiments given below, serve to explain the principles of the invention.

### DETAILED DESCRIPTION

Referring now to the drawing figures, wherein like numbers indicate like features through the views, an exemplary embodiment of a content capturing and control system for capturing, recording, and archiving live and pre-recorded music in a commercial venue will be described. As used herein, a commercial venue includes, but is not limited to, a restaurant, bar, concert hall, retail store, office, or the like, having a public address system for broadcasting music and/or messages to the patrons in the venue. The public address system will typically include a plurality of speakers mounted throughout the commercial venue for broadcasting audio, including musical performances and advertising, from an audio signal source. The commercial venue will typically also have one or more video screens for displaying videos, including advertisements, in the venue.

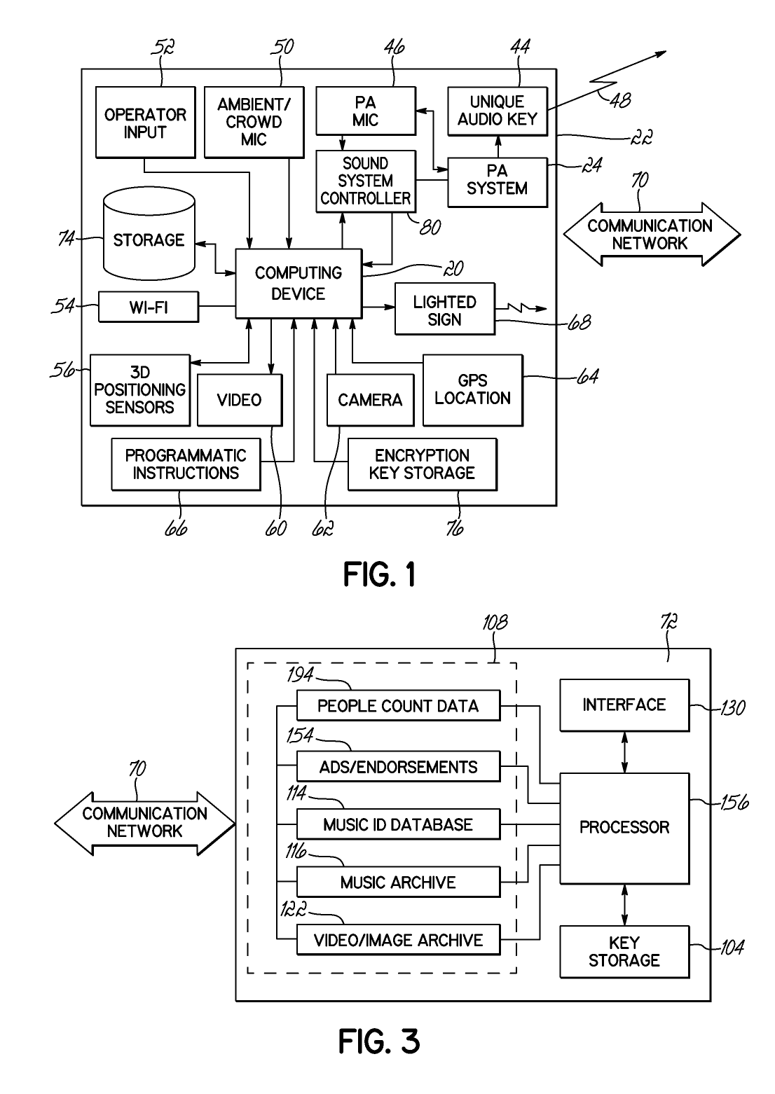

As shown in FIG. 1, the system described herein includes one or more computing devices 20 located in a venue 22 for capturing and recording performance data, monitoring and cataloging audience data, controlling content broadcast in the venue, and interacting with other components of the system. As used herein, a computing device 20 may include a computer, handheld computing device, tablet computer, smartphone, internet appliance, multifunction electronic device, or other portable device having processing capabilities. The computing device may include hardware (e.g., memory, processor, motherboard, graphic cards, etc.), software (e.g., operating system, applications, etc.), and an input mechanism (e.g. touch screen interface, keypad, etc.) to enable user interaction with the device. The computing device may exchange data or information with remotely located servers using available network or Internet services.

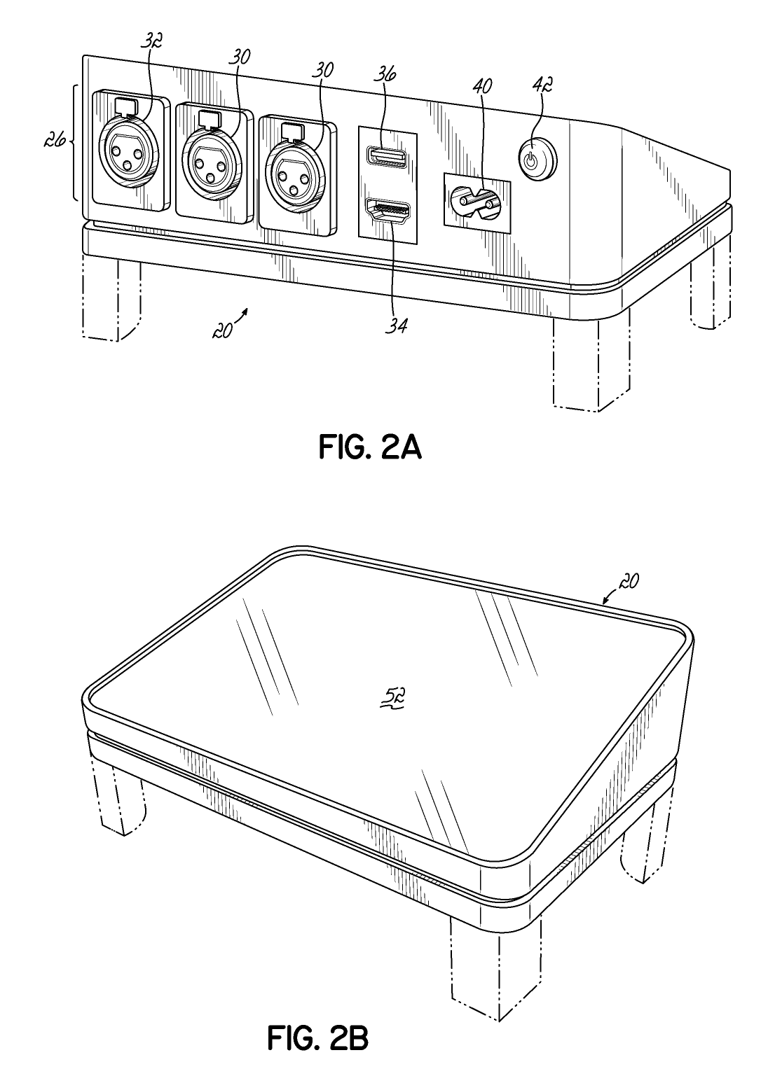

Computing device 20 is connected to the public address (PA) system 24 for tapping into the audio signal broadcast through the public address system. An electronic sound system controller 80, with amplifiers, volume, input selection, and other controls required to operate the public address system, is located between the PA system 24 and computing device 20. Computing device 20 includes a plurality of ports, indicated at 26, for inputting and outputting audio signals. The input/output ports 26 may include many of the most common audio connector ports, such as, for example, XLR ports, RCA ports, phone plug ports, S-video ports, VGA ports, and/or coaxial cable ports, configured for professional or live music performances. Computing device 20 taps into the audio signals traveling through the device to capture and store the audio signal. In the exemplary device embodiment illustrated in FIGS. 2A and 2B, computing device 20 includes an audio interface having two XLR input ports 30, an XLR output port 32, an HDMI interface port 34, and a USB interface port 36. Computing device 20 can be battery powered, but preferably includes a power connection 40, plugged into a power source in the venue, and an on/off control 42. As shown in FIG. 1, a unique audio key 44 can be associated with public address system 24 for encrypting audio signals broadcast through the system as indicated at 48.

The broadcast audio signals can come from a number of different sources. These audio signal sources include, but are not limited to, radio receivers, cable provider receivers, computers, mobile phones, tablets, and digital music players, such as MP3 players and DVD players. In addition to the connection to sound system controller 80, one or more microphones 46 can be provided for inputting audio signals, including announcements, music performances, and other broadcast data, into computing device 20. Additionally, one or more microphones 50 may be positioned at locations inside the venue 22 for detecting and inputting ambient or crowd sounds into computing device 20. Computing device 20 can include an interface panel 52 for receiving operator input for monitoring and controlling the device. Interface 52 can include a touchpad, keyboard, or other device for inputting operator instructions. Computing device 20 can further include a Wi-Fi connection 54, and connectors for three-dimensional positioning sensors 56. A video processor 60 and one or more cameras 62 can be connected with computing device 20 for outputting video data for display within the venue 22, as well as for capturing video or image data from within the venue. This captured video and image data can include crowd video and still photos for use in assessing crowd size and demographics. Computing device 20 can also include GPS positioning sensors 64 for associating location coordinates with audio and/or video data captured by the device. Computing device 20 also includes an input for programmatic instructions 66. A wireless connection is also provided for communicating with one or more data collection devices 68 located within the venue 22, as will be described in more detail below.

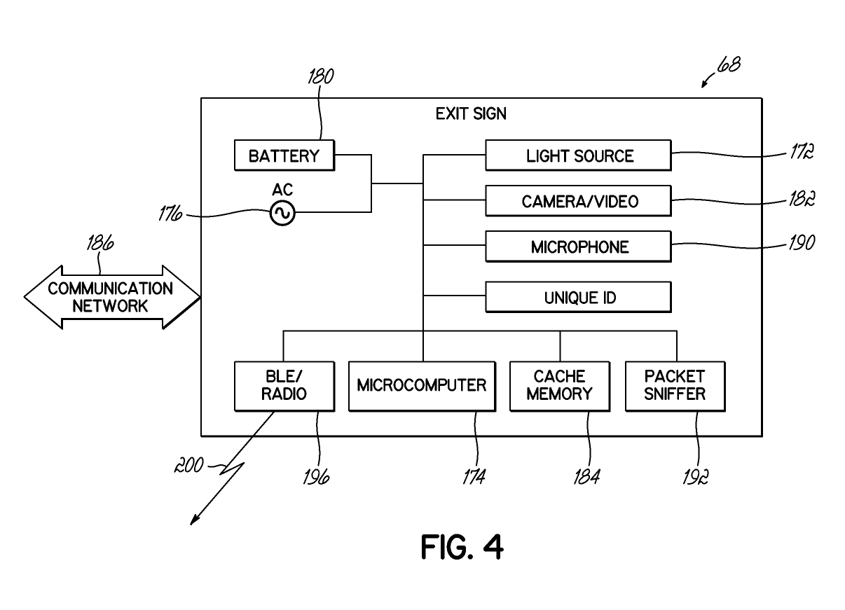

As shown in FIGS. 1 and 3, computing device 20 is connected to a central server 72, through a communication network 70, for two-way communication of audio, video, and other data between the venue computing device and the server. The communication network 70 can be the Internet, a telephone communication network, a cable connection network, a fiber optic communication network, or a wireless network, such as a cellular communication network. A database 74 in computing device 20 stores audio, video, photo images, multi-media interactions, and other wired or wireless data signals captured in the venue, as well as data communicated to the venue from server 72. Computing device 20 captures and converts the data signals into content data records for storage in database 74. The content data records have identifiers associated therewith including, but not limited to, the specific date and time that the data was broadcast in the venue. Location identifiers for the specific venue in which the broadcast occurred may be recorded by including a unique venue identification, or GPS coordinates, as part of the data record. Computing device 20 also includes an encryption key storage 76. Prior to transmission to server 72, content data records are encrypted in computing device 20 using a public encryption key from key storage 76.

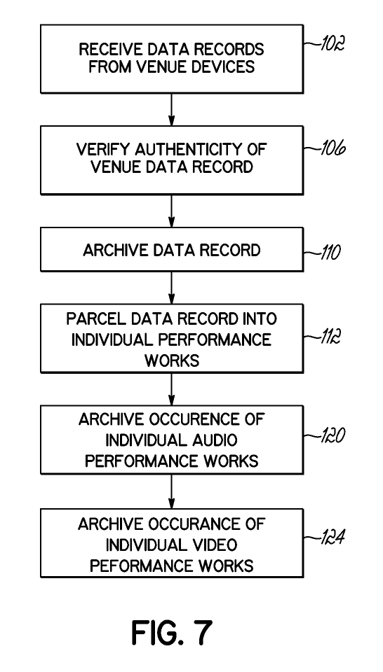

As shown in FIGS. 1 and 6, computing device 20 will be utilized in a commercial venue as an input/output source for a sound system controller 80. See Block 82. Computing device 20 will be connected to the sound system controller 80 to both receive audio signals from the controller, as well as output audio signals to the controller. See Block 84. Computing device 20 taps the audio signals as the signals travel between the computing device and sound system controller 80. In addition to audio signals from sound system controller 80, computing device 20 captures other audio and video content in the venue 22 using one or more of the components described above. See Block 86. As computing device 20 captures content in the venue 22, the computing device converts the content to an appropriate data format, and creates a data record of the content. Computing device 20 attaches the date, time, and venue location of the data capture to the content data record. See Block 90. Data records are created from the multiple forms of data (audio, video, photo, multi-media, wireless, etc.) captured at a specific time in venue 22. See Block 92. As the data records are created, the records are stored in database 74. See Block 94. Data records from the venue database 74 are encrypted using a public key from storage key 76. See Block 96. The encrypted data records are transmitted from the venue computing device 20 to the remote server 72 using communication network 70. See Block 100. The data transmissions can occur continuously, or at predetermined time periods, such as during low data traffic periods.

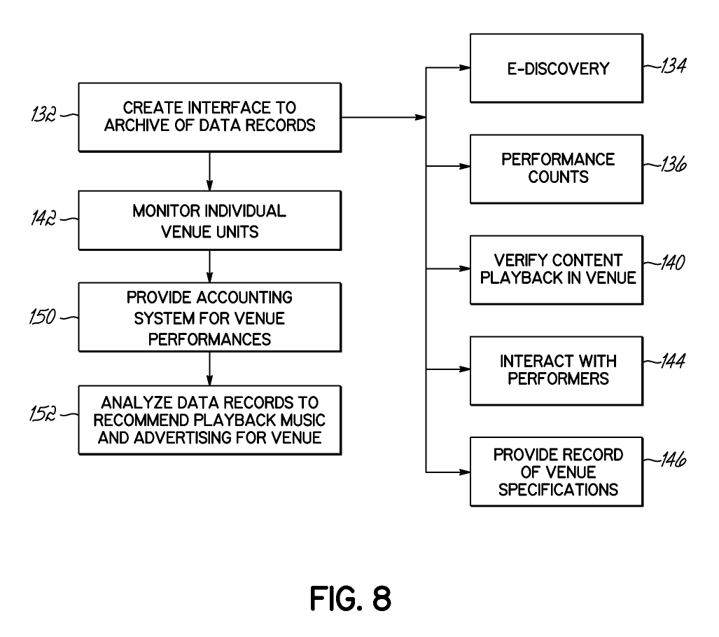

As shown in FIGS. 3 and 7, server 72 inputs content data records from one or more venue computing devices 20. See Block 102. Using a private key from a server key storage 104, the server software verifies the authenticity of the content data records transmitted from a venue, including all audio, video, photos, multimedia interactions, and wireless signals for a specific time and a specific venue computing device. See Block 106. After verification, the server software archives the full content data record in server data storage 108. See Block 110. In addition to archiving the full data record of broadcast content, the server 72 also opens, reviews, and separates the content data records. The server software separates and parcels the individual performance works, including audio, video, photos, multimedia interactions, and wireless signals, from the stream of data records into smaller files, or metadata, that define a start and stop of an individual work that contains copyrighted material, or that is otherwise subject to copyright, license, or a payment for performance agreement. See Block 112. Known commercial copyright databases, including, but not limited to, 7Digital®, Shazam®, and Soundhound® contain extensive libraries of all copyrighted audio material in a digital format. To parcel data records into individual performance works, the server 72 utilizes one of these commercial copyright databases, or includes a similar music ID database 114. Using known comparison algorithms, software in server 72 utilizes the music ID database 114 to analyze each incoming data record to identify individual audio performance works subject to copyright. If the server software detects that any segment of the incoming data record matches anything in the music ID database 114, then that segment of the data record is identified. Depending upon the duration of the identified segment of the data record, the segment may be archived as an individual audio performance work in a music archive 116. See Block 120. In a similar manner, individual video works may be identified in incoming content data records, and stored as individual performance works in a video/image archive 122. See block 124. Additional copies of the archived files may be made by the server software for backup purposes.

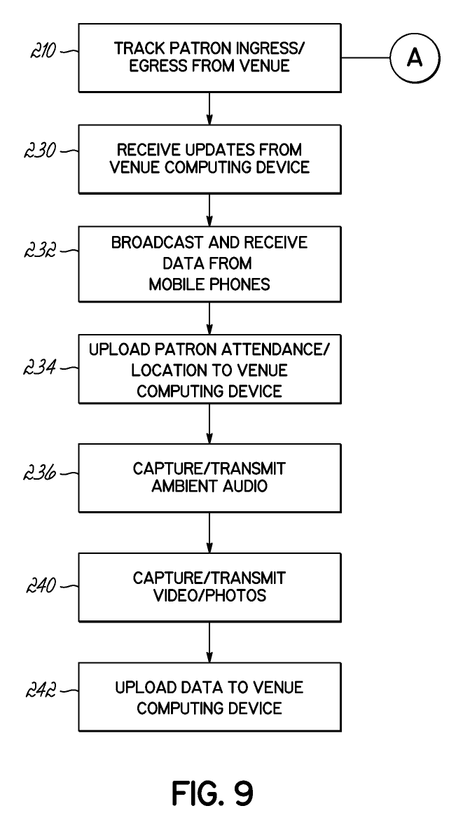

An interface 130 in server 72 provides a recall system for manual and programmatic interaction with each of the individual files in the music and video archives 116, 122, including the ability to search, view, copy, catalog, or otherwise manipulate and use the archived data files. See block 132 in FIG. 8. Interface 130 enables interaction with the data files to identify any audio, photos, video, multimedia interactions, or wireless signals that are subject to copyright, license, or payment for performance agreements for performing rights attribution. Additionally, interface 130 enables creation of new identifications of any individual audio, video, photos, multimedia interactions, and wireless signals that are subject to copyright, license, or payment for performance. Interface 130 provides a recall system for use in e-discovery of audio, video, and other broadcast data that is subject to copyright, license or payment for performance agreements. See Block 134. The recording in the content data records of the specific date, time, and location that a broadcast or performance occurs in a venue, as well as the encryption of the data records for transmission from the venue computing device 20 to server 72, authenticates the content data records, enabling the use of the records in e-discovery.

Interface 130 also allows for the analysis of archived data records in server 72 to determine the number of times (count) that an individual performance work was performed or broadcast in a particular venue. See Block 136. The count data provides for the calculation of appropriate royalty fees for the broadcast of individual audio works in a venue. Interface 130 may be used to generate reports for a Performing Rights Organization (PRO) of what copyrighted material was broadcast, as well as the specific date, time, and venue where the broadcast occurred. Interface 130 also provides the ability for a third party to verify the integrity of the encrypted content data records from one or more venues, as well as verify that a broadcast of particular, preselected content occurred in a venue. See Block 140. In addition, interface 130 provides for directly updating a content data record in server 72, by inputting data regarding particular performers and performances. In addition, interface 130 in server 72 allows for checking and verifying the proper operation of computing devices 20 in venues. In particular, server 72 can verify that a venue computing device 20 has power; is able to record audio, photos, video, multimedia interactions, and wireless signals; and has available storage space on a venue database 74. The interface in server 72 may also be used to locate missing data record inputs for related audio, photos, video, multimedia interactions, and wireless signals broadcast in the venue. Using interface 130 in server 72, performers have the ability to update or revise performance acts and titles, submit playlists to third party payment collection systems, download audio, video, and audience data for a performance, accept offers to create content for replay in a venue through the on-site computing device 20 in a venue, and receive payment for content and endorsements. See Block 144.

The server 72 can also monitor individual venue computing devices 20, and maintain a record of all venue locations, the dimensions of each venue location, occupancy limits for a venue, and advertising preferences for the venue. See Block 146. The server 72 may also provide an accounting system for the individual venues, allowing for third-party verification that selected advertising was delivered and displayed, revenue amounts and audience sizes were as reported, revenue was appropriately divided between a venue and third parties, and payment and tax information for a venue is accurate. See Block 150. As shown in Block 152, the content data records can be analyzed in server 72 by venue, and used in conjunction with crowd demographics captured and cataloged in a venue, to provide suggestions for audio playback in the venue, or to provide a service for music or video before, between, or after live performances. This analysis can also be used to determine the demographics of the audience present during broadcasts of particular genres of music. This linking of audience demographics and music genre can then be used to select advertising targeted at specific audience types, or for broadcast during performances of specific bands or music genre. The ads/endorsements can be stored in a database 154 in server 72. When collected audience data uploaded from a venue indicates that a particular audience demographic is present in the venue, or server 72 identifies the performance of a particular band or musician, the server processor 156 can select one or more advertisements from database 154, and download the advertisements in real-time to the computing device 20 in the venue. The advertisements can be broadcast in the venue 22 in conjunction with the music performance. For example, when server 72 identifies a particular performer scheduled in a venue, the server can select and download marketing content in which the performer provides product endorsements.

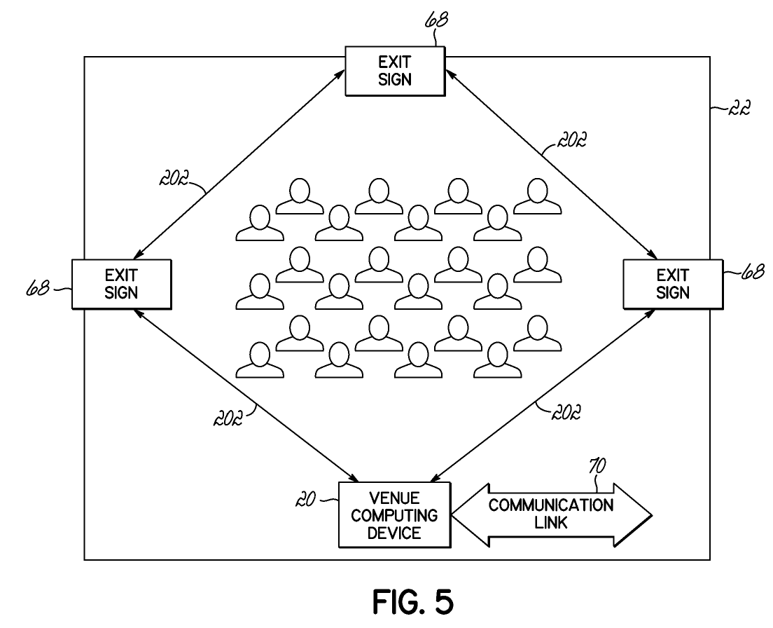

In addition to audio and video broadcast data, the system of the present invention also captures and tracks audience data, including audience size and crowd demographics, inside a venue. The audience data can be uploaded to server 72, and analyzed by the server to provide content suggestions for a venue. The system includes one or more lighting devices 68 having the capability of collecting audience data from within the venue. In addition to collecting data, the lighting device 68 described herein can also broadcast data to the audience in a venue. The broadcast data can be synchronized to an audio and/or video performance taking place in the venue. In an exemplary embodiment shown in FIG. 4, the lighting device 68 is housed in a safety sign, such as an EXIT sign, in the venue 22. The device 68 includes a light source 172, such as an LED fixture, and a microcomputer 174. The lighting device 68 is connected to a power source 176 for illuminating the light source 172, and providing a continuous power source for the device. A battery 180 can also be provided as a primary or backup power source for the device. A camera 182 can be located in the device for capturing video or still images within the venue. Camera 182 can capture venue images at a pattern determined by computing device 20. The captured images can be stored in the lighting device 68 in a memory 184, and communicated to venue computing device 20 through a communication link 186. Additionally, a microphone 190 can be included in the device 68 for capturing audio within the venue, including crowd noise adjacent the sign location in the venue.

Lighting device 68 further includes a packet analyzer or sniffer 192 for collecting audience data in the venue 22. The packet sniffer 192 enables device 68 to detect portable computing devices, otherwise referred to herein as “mobile phones”, in the venue, using the distinct mobile access code (MAC) for the mobile phone. The detected MAC identifiers are communicated from lighting device 68 to the venue computing device 20. The venue computing device 20 uses the MAC identifiers to count the number of patrons in the venue at any given point in time. In particular, the lighting device 68 can sniff a MAC identifier when a patron carrying a mobile phone enters the venue 22. The lighting device 68 stores the MAC of the patron's mobile phone in memory 184, and transmits the MAC to computing device 20 through communication network 186. The MAC may be stored in the venue computer 20 and/or communicated to server 72. Computing device 20 can track each identified MAC in the venue to calculate an audience count. The audience count data can be uploaded to server 72 and stored in a database 194. The audience count can be determined for specific intervals of time, or for a period of time, such as total venue attendance over an evening, or during a live music performance. Packet sniffer 192 will also detect when a previously-identified MAC exits the venue, and communicate this information to venue computer 20 to provide a real-time update of attendance in the venue.

In addition to calculating audience size, the detected MAC identifier can be used to identify the owner of the mobile phone, and to discern demographic characteristics of the owner. These demographic characteristics can include age, gender, hometown, etc. Determining demographic characteristics through the MAC identifier will enable the system to programmatically alter content performed within the venue. In particular, using the demographic data, the system can determine audience characteristics during particular types of broadcasts (i.e. live music verses pre-recorded music, different music genres, etc.). Using this information, the control system described herein can provide broadcasts and advertising targeted to the primary demographic groups represented in the audience. The broadcast content can be varied based on the demographics present in the venue for different genre of music. A data storage device, such as cache memory 184, can be provided in the lighting device 68 for temporarily storing data received through the microphone 190, camera 182, and/or packet sniffer 192 prior to communicating the data to the venue computing device 20.

As shown in FIG. 4, lighting device 68 also includes a wireless interface 196 capable of communicating on several standards simultaneously. The wireless interface 196 can include a Bluetooth® low energy (BLE) chip, or similar wireless communication device, for broadcasting advertising and marketing content within the venue, as indicated by arrow 200. The BLE chip broadcasts create interactions between the broadcasted advertising data and microcode on patron mobile phones, to push advertising and marketing content to patrons in the venue. The advertising broadcasts can be tailored to the type of audience in the venue, by first detecting and analyzing MAC identifiers from the venue audience.

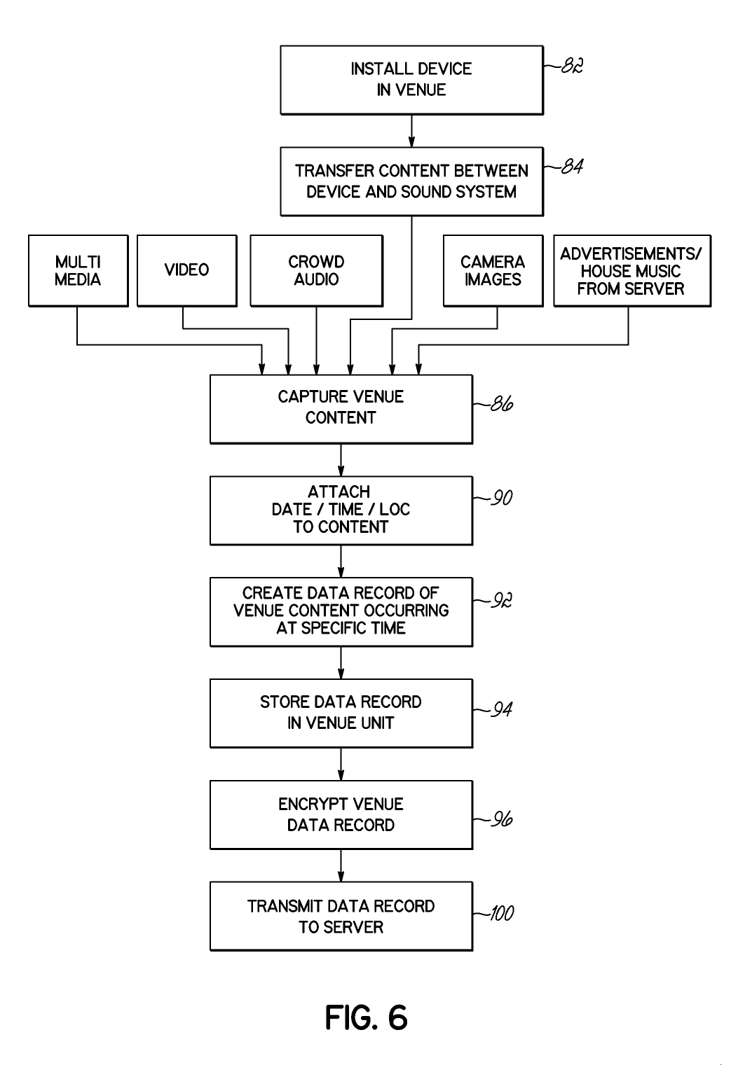

As shown in FIG. 5, a plurality of the lighting devices 68 may be located within a single venue 22 in order to share data between the devices in a mesh format, as indicated by the arrows 202. The devices communicate through the network to share data between the devices and venue computing device 20. The multiple devices 68 in the mesh network can comprise a triangular network for communicating with each other and computing device 20, to synchronize the broadcasting of data from the BLE chip 196 with audio and/or video performances in the venue. Additionally, venue computing device 20 may communicate with devices in mesh network 202 to interact with microcode on mobile phones in the venue. Mesh network 202 can provide three-dimensional location services of patron MAC identifiers via triangulation of the lighting devices 68 in the network. Mesh network 202 can be used to share data and receive computer code instructions from venue computing device 20, verify participation of each device in the network, send and receive voting data(?), share data between the lighting devices 68 and venue computing device 20, and verify the location of each of the devices. The lighting devices 68 in mesh network 202 can also be used to synchronize the projection or perception of augmented reality provided by goggles, glasses, headphones or other audio/visual devices used by a human. The projection is synchronized to bring the visual and audio provided to a human in alignment with the physical location, such as aligning a stage performance with additional visual effects. For multiple humans to jointly experience this effect, each human would need a specific geospatial location to align their perception in the venue. Mesh network 202 of lighting devices 68 can provide the X, Y, Z axis geospatial positioning in the venue.

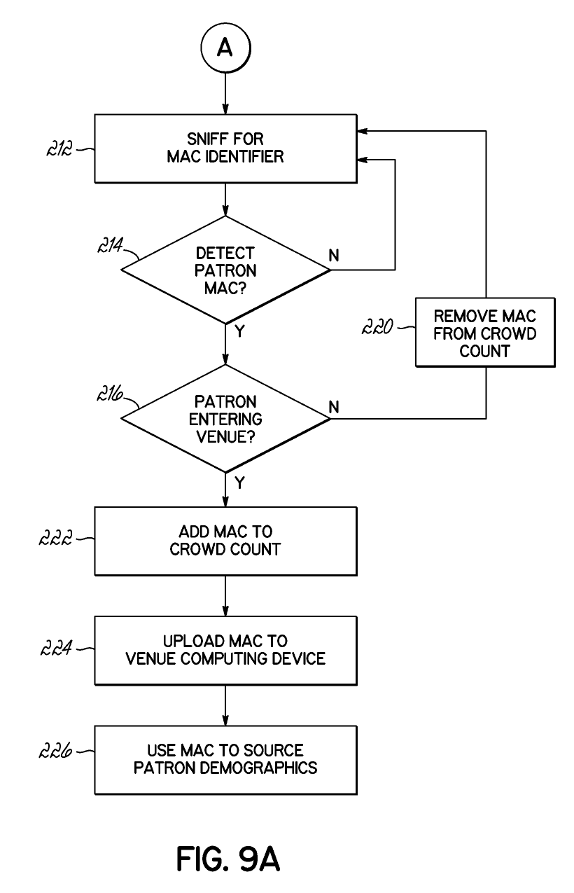

Turning to FIGS. 9 and 9A, in an exemplary embodiment lighting devices 68 are located at entrance/exits for the venue 22 in order to track patrons entering and leaving the venue 22. See Block 210. As shown in Block 212 of FIG. 9A, devices 68 sniff incoming and outgoing patrons for MAC identifiers. When a device 68 detects a MAC (Block 214), the device checks whether the patron is entering or exiting the venue, by looking at whether the MAC is new or has been previously identified (Block 216). To check the status of a MAC, microcomputer 174 in the lighting devices 68 will search for the presence of the MAC in a memory 184 of one of the devices in network 202. If the MAC has previously been identified in the venue and cached in a memory 184, the patron is determined to be leaving the venue. The MAC is removed from memory 184 in devices 68, and the crowd count is decreased by one. See Block 220. If the MAC identifier is not present in a memory 184 of the networked lighting devices 68, the patron is determined to be entering the venue 22. The crowd count is increased by 1. See Block 222. MAC identifiers in each device memory 184 are periodically uploaded to data storage 74 in venue computing device 20. See Block 224. The MAC identifiers may also be uploaded to server 72. Server software can use the MAC identifiers to source patron demographics relating to a specific date, time, and venue location. See Block 226. The demographic data for a specific date, time, and venue location may be linked to the broadcast content data record for the same date, time, and venue location in the server database 108. The demographic data may be stored with the audience count in server database 194.

Returning to FIG. 9, in addition to sourcing patron count and demographics, the lighting devices 68 receive updates from venue computing device 20. These updates can be directly from the computing device 20, or through the network 202. See Block 230. Network 202 is also used to circulate suggested advertising content for broadcast from BLE beacons 196. See Block 232. Networked lighting devices 68 will continually update the other devices and computing device 20 with current patron identifications and counts. See Block 234. Networked lighting devices 68 may also continually capture ambient audio and video images from the device's separate locations in the venue 22. See Blocks 236 and 240. The lighting devices 68 will routinely upload the captured audio and video to venue computing device 20. See Block 242.

The data captured through the lighting devices 68 is uploaded to central server 72 for analysis and selecting of suggested content for the venue. This suggested content can include advertising targeted to the predominant demographic traits of the audience present at that date and time in the venue. Alternatively, the suggested content can be selected based upon the music to be performed in the venue at a specific date and time. The server 72 can monitor the content captured in a venue to detect when a pre-recorded or live performance starts and stops, in order to download the selected advertising and house music for broadcasting before, after, and during breaks in performances in the venue.

The system described herein provides for a centralized archive of all performance content from multiple, managed venues, allowing for third party auditing and attribution of performance rights for the content. The system also provides for collecting and tracking crowd demographics and audience size across events in a venue, providing an identification of the music performers having popularity with audiences of particular demographics. This identification allows the system to target endorsements and other marketing content at particular audiences in a venue. Using sourced crowd counts and demographic data, the system described herein provides for the remote management of advertisement blocks broadcast within a number of different commercial venues. A central server will select the advertising for a particular venue based upon the types of music broadcast within the venue, as determined from content data records from the venue as well as audience data sourced from a venue.

The present invention has been described in connection with an exemplary embodiment in order to set forth one of the best modes contemplated for the invention. The illustrated embodiment, however, is merely exemplary and should not be considered a limitation when interpreting the scope of the appended claims.

What is claimed is:

1. A system for auditing performance data in commercial venues, the system comprising:
one or more computing devices located in venues where live or pre-recorded music is performed, the computing devices capturing and storing content in each venue, the content including live and pre-recorded performances captured using at least one audio input configured for professional audio performances, the computing devices storing the content within each venue as a content data record with associated identifiers for date, time, and venue location;
a communication network for transmitting content data records from each venue computing device to a server;
encryption keys for encrypting the content data records from each venue to verify the authenticity of the content transmitted from the venues to the server;
a database associated with the server for archiving content data records transmitted from one or more venues, the server including a processor for opening, reviewing, and separating the content data records from each venue into distinct files, each file comprising an individual audio and/or video work performed in the venue; and
an interface associated with the server for providing access to the archived content data records.

2. The system of claim 1, wherein the interface provides for identifying individual performance works by venue from the archived content data records for attribution of performance rights.

3. The system of claim 1, wherein the server collects audience data from individual venues, the data including patron demographics and audience size, and the server evaluates the audience data and content data records from individual venues to suggest content for performance within a venue.

4. The system of claim 3, wherein the suggested content for a venue includes music and/or video to be played in the venue between performances.

5. The system of claim 3, wherein the suggested content for a venue includes marketing content to be broadcast within the venue.

6. A method for auditing performance data in commercial venues, the method comprising the steps of:
locating computing devices in one or more commercial venues where live or pre-recorded music is performed, each computing device capturing and storing live and pre-recorded performances occurring in the venue using at least one audio input configured for professional audio performances, each computing device storing the performances within the associated venue as a content data record with associated identifiers for date, time, and venue location;
transmitting content data records from each venue computing device to a server;
encrypting the content data records from each venue to verify the authenticity of the content data transmitted from each venue to the server;
archiving the content data records transmitted from the one or more venues to the server;
opening, reviewing, and separating the archived content data records into distinct files, each file comprising an individual audio and/or video work performed in the venue; and
using an interface associated with the server to access the archived content data records for identifying individual performance works by venue for attribution of performance rights.

7. A device for collecting audience data and providing broadcasts within a performance venue, the device comprising:
a light bulb;
a power source for illuminating the light bulb;
a wireless interface for communicating with a computing device in the venue;
a microcomputer; and
a packet sniffer.

8. The device of claim 7, wherein the device is enclosed within a housing of a safety sign in a commercial venue for the performance of live and pre-recorded music.

9. The device of claim 7, wherein the microcomputer comprises a BLE chip for broadcasting data in the venue.

10. The device of claim 9, where the device is one of multiple similar devices in a mesh network, the multiple devices communicating through the network to share data between the devices and the venue computing device.

11. The device of claim 10, wherein the device communicates with other similar devices and the venue computing device to synchronize the broadcasting of data from the BLE chip with audio and/or video performances in the venue.

12. The device of claim 9, wherein the device is positioned relative to other similar devices in the venue to comprise a triangular network, and wherein the packet sniffers in the devices detect and share portable computing device identifiers within the network, and with the venue computing device, to track patron locations within the venue.

13. The device of claim 7, wherein the device is located at an entry point for the venue to detect entry of patrons to the venue through interception by the packet sniffer of portable computing device identifiers associated with a patron.

14. The device of claim 13, wherein the device cooperates with other similar devices in a mesh network in the venue to track patron location using packet sniffers in each device, and wherein the device communicates patron entrance or exit from the venue to the venue computing device either directly or using the mesh network.

15. The device of claim 13, wherein audience data sourced from the packet sniffers is used to programmatically alter content performed within the venue.

16. The device of claim 10, wherein the BLE chip broadcasts advertising data in the venue for creating interactions between the advertising data and microcode on patron portable computing devices.

17. The device of claim 7, wherein the device further comprises a camera for capturing images within the venue.

18. The device of claim 7, wherein the device further comprises a microphone for capturing audio within the venue.

19. A system for capturing audience data and for broadcasting marketing content in a performance venue, the system comprising:
a plurality of lighting devices, each of the lighting devices including a light bulb, a power source for illuminating the light bulb, a wireless interface, a microcomputer, and a packet sniffer for intercepting and recording portable computing device identifiers of patrons entering the venue; and
a computing device in the venue, the computing device communicating with the lighting devices through the wireless interface, the lighting devices capturing patron data using the packet sniffers and communicating the patron data to the venue computing device.

20. The system of claim 19, wherein the lighting devices further comprise a BLE beacon for broadcasting data within the venue.

21. The system of claim 20, wherein the network of lighting devices communicates with the venue computing device to synchronize the broadcasting of data with performance events in the venue.

22. A method for driving advertising in a performance venue, the method comprising the steps of:
detecting entrance of a patron into a venue;
adding each patron entrance to an audience count for the venue;
determining demographic data for patrons using identifiers associated with patron portable computing devices carried into the venue; and
correlating patron demographic data with music performances occurring within the venue to develop suggested content for the venue.

23. The method of claim 22, wherein the suggested content for the venue includes marketing content for broadcast within the venue.

24. The method of claim 23, wherein the step of correlating demographic data with music performances is performed by a server at a remote location from the venue.

25. The method of claim 23, further comprising the steps of capturing audio and/or video data in a venue, and using the captured data in conjunction with the patron demographic data to set pricing for marketing content broadcast within the venue.

26. The method of claim 23, further comprising the step of capturing audio and/or video data from within a venue, and using the captured data to verify broadcast of the marketing content in the venue.

27. The method of claim 22, wherein the step of developing suggested content for the venue further comprises identifying potential performers for use in marketing content for the venue.
